(19) United States
(12) Patent Application Publication
(10) Pub. No.: US 2025/0174628 A1
(43) Pub. Date: May 29, 2025

(54) LITHIUM-ION BATTERY AND MANUFACTURING METHOD FOR LITHIUM-ION BATTERY

(71) Applicant: TOYOTA JIDOSHA KABUSHIKI KAISHA, Toyota-shi (JP)

(72) Inventor: So YUBUCHI, Sunto-gun (JP)

(73) Assignee: TOYOTA JIDOSHA KABUSHIKI KAISHA, Toyota-shi (JP)

(21) Appl. No.: 18/946,579

(22) Filed: Nov. 13, 2024

(30) Foreign Application Priority Data
Nov. 27, 2023 (JP) 2023-200047

(51) Int. Cl. H01M 4/131; H01M 4/02; H01M 4/04; H01M 10/0525; H01M 10/0562

(52) U.S. Cl. CPC H01M 4/131; H01M 4/043; H01M 10/0525; H01M 10/0562; H01M 2004/021; H01M 2004/028

(57) ABSTRACT

A lithium-ion battery having low resistance is disclosed. The lithium-ion battery of the present disclosure comprises a positive electrode active material layer, an electrolyte layer, and a negative electrode active material layer, wherein the positive electrode active material layer comprises a positive electrode active material having a Li-deficient O2-type structure and a sulfide solid electrolyte, and a Raman spectrum of the positive electrode active material layer satisfies relationships of I_{R1}/I_{R2}≤0.20 and I_{R3}/I_{R2}≤0.20 (I_{R1}: peak intensity from P₂S₆⁴⁻ in the Raman spectrum, I_{R2}: peak intensity from PS₄³⁻ in the Raman spectrum, and I_{R3}: peak intensity from S—S in the Raman spectrum).

### FIELD

The present application discloses a lithium-ion battery and a manufacturing method for a lithium-ion battery

### BACKGROUND

PTL 1 discloses a positive electrode active material for an all-solid battery having an O2-type structure (O: octahedral). A positive electrode active material having an O2-type structure is obtained by subjecting at least a portion of Na in a Na-containing oxide having a P2-type structure to ion exchange with Li. The positive electrode active material thus obtained has a Li-deficient O2-type structure. Specifically, the compositional ratio Li/O of Li and O constituting the O2-type structure is normally less than 0.5.

### CITATION LIST

### Patent Literature

[PTL 1] Japanese Unexamined Patent Publication No. 2022-085829

### SUMMARY

### Technical Problem

Lithium-ion batteries that use a positive electrode active material having a Li-deficient O2-type structure have room for improvement in terms of resistance.

### Solution to Problem

The present application discloses the following plurality of aspects as means for achieving the above object.

### <Aspect 1>

A lithium-ion battery, comprising a positive electrode active material layer, an electrolyte layer, and a negative electrode active material layer, wherein
the positive electrode active material layer comprises
   a positive electrode active material having a Li-deficient O2-type structure and
   a sulfide solid electrolyte, and
a Raman spectrum of the positive electrode active material layer satisfies relationships (1) and (2) below:

$${I}_{R 1} / {I}_{R 2} \leq 0.2 ; \qquad ( 1 )$$

$${I}_{R 3} / {I}_{R 2} \leq 0.2 ; \qquad ( 2 )$$

I_{R1}: peak intensity from P₂S₆⁴⁻ in the Raman spectrum;
I_{R2}: peak intensity from PS₄³⁻ in the Raman spectrum;
I_{R3}: peak intensity from S—S in the Raman spectrum.

### <Aspect 2>

The lithium-ion battery according to Aspect 1, wherein
an XPS spectrum of the positive electrode active material layer satisfies relationships (3) and (4) below:

$${I}_{X 1} / {I}_{X 2} \leq 1.2 ; \qquad ( 3 )$$

$${I}_{X 3} / {I}_{X 4} \leq 1.6 ; \qquad ( 4 )$$

I_{X1}: peak intensity from P—S—P in the XPS spectrum for S2p;
I_{X2}: peak intensity from PS₄³⁻ in the XPS spectrum for S2p;
I_{X3}: peak intensity from POₓS₄₋ₓ³⁻ in the XPS spectrum for P2p;
I_{X4}: peak intensity from PS₄³⁻ in the XPS spectrum for P2p.

### <Aspect 3>

The lithium-ion battery according to Aspect 1 or 2, wherein
when an entire solid content contained in the positive electrode active material layer is 100% by mass,
   a content of the positive electrode active material is 40% by mass or greater and less than 100% by mass, and
   a content of the sulfide solid electrolyte is greater than 0% by mass and 60% by mass or less.

### <Aspect 4>

The lithium-ion battery according to any of Aspects 1 to 3, wherein
the positive electrode active material has a chemical composition represented by LiₐNa_{b}Mnₓ₋ₚNi_{y-q}Co_{z-r}M_{p+q+r}O₂, where 0<a<1.00; 0≤b≤0.20; x+y+z=1; and 0≤p+q+r<0.17, and an element M is at least one selected from B, Mg, Al, K, Ca, Ti, V, Cr, Fe, Cu, Zn, Ga, Ge, Sr, Y, Zr, Nb, Mo, and W.

### <Aspect 5>

The lithium-ion battery according to any of Aspects 1 to 4, wherein
the electrolyte layer comprises a solid electrolyte.

### <Aspect 6>

A manufacturing method for a lithium-ion battery, the method comprising
mixing a positive electrode active material having a Li-deficient O2-type structure and a sulfide solid electrolyte to obtain a positive electrode mixture, and
pressing the positive electrode mixture at a temperature of lower than 165° C. to obtain a positive electrode active material layer.

### Effects

The lithium-ion battery of the present disclosure has low resistance.

### BRIEF DESCRIPTION OF DRAWINGS

FIG. 1 schematically shows one example of a configuration of the lithium-ion battery.

FIG. 2 shows one example of the flow of the manufacturing method for a lithium-ion battery.

FIG. 3 shows a Raman spectrum for each of the positive electrode active material layers of Examples 1 and 2, Comparative Examples 1 to 3, and Reference Example.

FIG. 4 shows an XPS spectrum (P2p) for each of the positive electrode active material layers of Examples 1 and 2, Comparative Examples 1 to 3, and Reference Example.

FIG. 5 shows an XPS spectrum (S2p) for each of the positive electrode active material layers of Examples 1 and 2, Comparative Examples 1 to 3, and Reference Example.

### DESCRIPTION OF EMBODIMENTS

Hereinafter, one embodiment for each of the lithium-ion battery and the manufacturing method therefor of the present disclosure will be described. However, the lithium-ion battery and the manufacturing method therefor of the present disclosure are not limited to the embodiments described below.

### 1. Lithium-Ion Battery

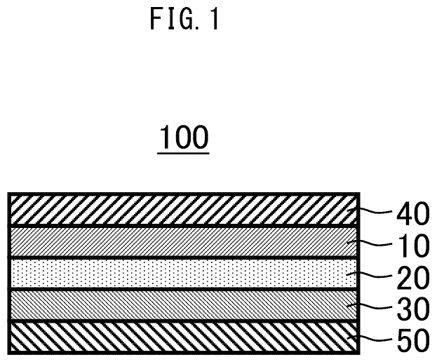

As shown in FIG. 1, the lithium-ion battery 100 according to one embodiment comprises a positive electrode active material layer 10, an electrolyte layer 20, and a negative electrode active material layer 30. The positive electrode active material layer 10 comprises a positive electrode active material having a Li-deficient O2-type structure and a sulfide solid electrolyte. A Raman spectrum of the positive electrode active material layer 10 satisfies relationships (1) and (2) below:

$${I}_{R 1} / {I}_{R 2} \leq 0.2 ; \qquad ( 1 )$$

$${I}_{R 3} / {I}_{R 2} \leq 0.2 ; \qquad ( 2 )$$

I_{R1}: peak intensity from P₂S₆⁴⁻ in the Raman spectrum;
I_{R2}: peak intensity from PS₄³⁻ in the Raman spectrum;
I_{R3}: peak intensity from S—S in the Raman spectrum.

The lithium-ion battery 100 that satisfies the relationships (1) and (2) has low resistance.

### 1.1 Positive Electrode Active Material Layer

The positive electrode active material layer 10 comprises a positive electrode active material having a Li-deficient O2-type structure and a sulfide solid electrolyte. The positive electrode active material layer 10 may optionally comprise an additional positive electrode active material, an additional electrolyte, a conductive aid, and a binder. The positive electrode active material layer 10 may additionally comprise various additives. The content of each of the positive electrode active material, electrolyte, conductive aid, and binder in the positive electrode active material layer 10 may be appropriately determined according to target battery performance. For example, when the entire solid content contained in the positive electrode active material layer 10 is 100% by mass, the content of the positive electrode active material having a Li-deficient O2-type structure may be 40% by mass or greater and less than 100% by mass, and the content of the sulfide solid electrolyte may be greater than 0% by mass and 60% by mass or less. The content of the positive electrode active material having a Li-deficient O2-type structure may be 50% by mass or greater, 60% by mass or greater, 70% by mass or greater, or 80% by mass or greater, and may be 90% by mass or less, and the content of the sulfide solid electrolyte may be 10% by mass or greater, and may be 50% by mass or less, 40% by mass or less, 30% by mass or less, or 20% by mass or less. These lower limit values and upper limit values may be arbitrarily combined.

### 1.1.1 Positive Electrode Active Material Having Li-Deficient O2-Type Structure

The positive electrode active material layer 10 comprises a positive electrode active material having a Li-deficient O2-type structure (belonging to space group P63mc). In other words, the positive electrode active material layer 10 comprises a Li-containing oxide having a Li-deficient O2-type structure as a positive electrode active material. “Li-deficient” refers to having a compositional ratio Li/O of Li and O of less than 0.5 in the chemical composition of a positive electrode active material (for example, “a” in the chemical formula described below being less than 1.0).

### 1.1.1.1 Crystal Structure

The positive electrode active material according to one embodiment may have a crystal structure other than an O2-type structure in addition to having an O2-type structure. Examples of crystal structures other than an O2-type structure include a T #2-type structure (belonging to space group Cmca) and an O6-type structure (belonging to space group R-3m, with a c-axis length of 2.5 nm or more and 3.5 nm or less, typically 2.9 nm or more and 3.0 nm or less, and differing from an O3-type structure belonging to the same space group R-3m), formed when Li is deintercalated from an O2-type structure. Any of the crystal structures can be a Li-deficient crystal structure. The positive electrode active material according to one embodiment may have an O2-type structure as the main phase or may have a crystal structure (for example, O6-type structure) other than an O2-type structure as the main phase. The positive electrode active material according to one embodiment can have, depending on the charge and discharge states thereof, a crystal structure for the main phase that changes.

### 1.1.1.2 Crystallite

The positive electrode active material having a Li-deficient O2-type structure may be a single crystal consisting of one crystallite, or may be a polycrystal having a plurality of crystallites. For example, the positive electrode active material according to one embodiment may be composed of, on the surface thereof, a plurality of crystallites. In other words, the positive electrode active material on the surface thereof may have a structure in which a plurality of crystallites are connected to each other. When the surface of the positive electrode active material is composed of a plurality of crystallites, crystal grain boundaries are present on the surface. In this case, the crystal grain boundaries may become entrances and exits for intercalation. Specifically, when the positive electrode active material consists of a polycrystal having a plurality of crystallites, expected effects include a decrease in reaction resistance due to the increased number of intercalation entrances and exits, a decrease in diffusion resistance due to shortened migration distance of lithium ions, and prevention of cracking due to a decrease in absolute quantities of expansion and contraction amounts during charging and discharging. The size of the crystallites may be large or small. However, it is considered that the smaller the size of the crystallites, the more crystal grain boundaries there are, and the more easily the above advantageous effects are demonstrated. For example, when the diameter of the crystallites constituting the positive electrode active material is less than 1 μm, higher performance is easily obtained. Note that “crystallite” and “diameter of crystallite” can be determined by observing the surface of the positive electrode active material with a scanning electron microscope (SEM) or a transmission electron microscope (TEM). Specifically, when the surface of the positive electrode active material is observed and one closed region surrounded by crystal grain boundaries is observed, the region is regarded as a “crystallite”. The maximum Feret diameter of the crystallite is determined, and this is regarded as the “diameter of the crystallite”. If the positive electrode active material consists of single-crystal particles, the particle itself is considered as one crystallite, and the maximum Feret diameter of the particle is the diameter of the crystallite. When the diameter of the crystallite of the positive electrode active material is less than 1 μm, higher performance is easily demonstrated. The crystallites constituting the positive electrode active material may have a first surface exposed on the surface of the oxide, and the first surface may be planar. Specifically, the surface of the positive electrode active material may have a structure in which a plurality of planes are connected. As described below, when manufacturing a Na-containing oxide as a raw material for a Li-containing oxide to be a positive electrode active material, crystallites having a planar first surface are easily obtained by growing crystallites on the surface of the particle until one crystallite and another crystallite are connected to each other.

### 1.1.1.3 Chemical Composition

The positive electrode active material having a Li-deficient O2-type structure, for example, may at least comprise, as constituent elements, at least one element among Mn, Ni, and Co; Li; and O. In the positive electrode active material, particularly when at least Li, Mn, one or both of Ni and Co, and O are included as constituent elements, especially when at least Li, Mn, Ni, Co, and O are included as constituent elements, higher performance is easily obtained.

The positive electrode active material having a Li-deficient O2-type structure may have a chemical composition represented by LiₐNa_{b}Mnₓ₋ₚNi_{y-q}Co_{z-r}M_{p+q+r}O₂ (where 0<a<1.00; 0≤b≤0.20; x+y+z=1; and 0≤p+q+r<0.17, and the element M is at least one selected from B, Mg, Al, K, Ca, Ti, V, Cr, Fe, Cu, Zn, Ga, Ge, Sr, Y, Zr, Nb, Mo, and W). When the positive electrode active material has such a chemical composition, an O2-type structure is easily maintained. In the chemical composition above, a is greater than 0 and may be 0.10 or greater, 0.20 or greater, 0.30 or greater, 0.40 or greater, 0.50 or greater, or 0.60 or greater, and is less than 1.00 and may be 0.90 or less, 0.80 or less, or 0.70 or less. In the chemical composition above, b is 0 or greater and may be 0.01 or greater, 0.02 or greater, or 0.03 or greater, and is 0.20 or less and may be 0.15 or less or 0.10 or less. In addition, x is 0 or greater and may be 0.10 or greater, 0.20 or greater, 0.30 or greater, 0.40 or greater, or 0.50 or greater, and is 1.00 or less and may be 0.90 or less, 0.80 or less, 0.70 or less, 0.60 or less, or 0.50 or less. Further, y is 0 or greater and may be 0.10 or greater or 0.20 or greater, and is 1.00 or less and may be 0.90 or less, 0.80 or less, 0.70 or less, 0.60 or less, 0.50 or less, 0.40 or less, 0.30 or less, or 0.20 or less. Moreover, z is 0 or greater and may be 0.10 or greater, 0.20 or greater, or 0.30 or greater, and is 1.00 or less and may be 0.90 or less, 0.80 or less, 0.70 or less, 0.60 or less, 0.50 or less, 0.40 or less, or 0.30 or less. The element M has a small contribution towards charging and discharging. In this regard, in the above chemical composition, by having p+q+r less than 0.17, high charge and discharge capacities are easily ensured. p+q+r may be 0.16 or less, 0.15 or less, 0.14 or less, 0.13 or less, 0.12 or less, 0.11 or less, or 0.10 or less. By including the element M, an O2-type structure is easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of 0 is approximately 2, but may be variable without being limited to exactly 2.0.

### 1.1.1.4 Shape

The positive electrode active material having a Li-deficient O2-type structure, as described below, can be obtained by substituting Na in a Na-containing oxide having a P2-type structure with Li. The P2-type structure has a hexagonal crystal system and a large Na ion diffusion coefficient, and crystals are easily grown in a specific direction. Particularly, when a transition metal element constituting the P2-type structure includes at least one of Mn, Ni, and Co, tabular crystals are grown easily in a specific direction. Therefore, a Na-containing oxide having a P2-type structure generally forms into tabular particles having a large aspect ratio, wherein crystal growth direction is biased in a specific direction. The positive electrode active material according to one embodiment may be obtained based on such tabular Na-containing oxide particles, or may be obtained based on spherical Na-containing oxide particles as described below. Specifically, the shape of the positive electrode active material may be of a tabular particle, or may be of a spherical particle. When the positive electrode active material is a spherical particle, reaction resistance is decreased due to the decrease in crystallite size, and diffusion resistance inside the particle is easily decreased. Further, when applied to a battery, it is considered that the degree of curvature is decreased by spheroidization, and lithium-ion conduction resistance is decreased, whereby, for example, rate characteristics are improved and reversible capacity is easily increased. A “spherical particle” in the present application means a particle having a circularity of 0.80 or greater. The circularity of the spherical particle may be 0.81 or greater, 0.82 or greater, 0.83 or greater, 0.84 or greater, 0.85 or greater, 0.86 or greater, 0.87 or greater, 0.88 or greater, 0.89 or greater, or 0.90 or greater. The circularity of a particle is defined as 4πS/L², where S is the orthographic area of the particle and L is the circumference of an orthographic image of the particle. The circularity of a particle can be determined by observing the exterior of the particle with a scanning electron microscope (SEM), a transmission electron microscope (TEM), or an optical microscope.

The positive electrode active material having a Li-deficient O2-type structure, for example, may be solid particles, may be hollow particles, or may be particles having voids. The size of the positive electrode active material particles is not particularly limited. However, a smaller size is considered advantageous. For example, the average particle size (D50) of the positive electrode active material particles may be 0.1 μm or more and 10 μm or less, 1.0 μm or more and 8.0 μm or less, or 2.0 μm or more and 6.0 μm or less. Note that the average particle size (D50) is the 50% cumulative particle size (D50, median diameter) in a volume-based particle size distribution determined by a laser diffraction/scattering method.

### 1.1.1.5 Manufacturing Method of Positive Electrode Active Material Having Li-Deficient O2-Type Structure

The positive electrode active material having a Li-deficient O2-type structure can be manufactured by, for example, the following method. Specifically, the manufacturing method of the positive electrode active material according to one embodiment comprises
S1: obtaining a precursor (for example, a precursor comprising at least one element among Mn, Ni, and Co),
S2: covering a surface of the precursor with a Na source to obtain a composite,
S3: firing the composite to obtain a Na-containing oxide having a P2-type structure, and
S4: subjecting at least a portion of Na in the Na-containing oxide to ion exchange with Li to obtain a Li-containing oxide having an O2-type structure.

The S3 comprises
53-1: subjecting the composite to a pre-firing at a temperature of 300° C. or higher and lower than 700° C. for 2 h or more and 10 h or less,
S3-2: following the pre-firing, subjecting the composite to a main firing at a temperature of 700° C. or higher and 1100° C. or lower for 30 min or more and 48 h or less, and
S3-3: following the main firing, rapidly cooling the composite from a temperature T₁ of 200° C. or higher to a temperature T₂ of 100° C. or lower.

In S1, a precursor comprising at least one element among Mn, Ni, and Co is obtained. The precursor may comprise at least Mn and one or both of Ni and Co, or may comprise at least Mn, Ni, and Co. The precursor may be a salt comprising at least one element among Mn, Ni, and Co. The precursor, for example, may be at least one of a carbonate, a sulfate, a nitrate, and an acetate. Alternatively, the precursor may be a compound other than a salt. The precursor, for example, may be a hydroxide. The precursor may be a hydrate. The precursor may be a combination of a plurality of compounds. The precursor may be of various shapes. For example, the precursor may be particulate, and may be spherical particles as described below. The particle size of the particles consisting of the precursor is not particularly limited.

In S1, a precipitate as the precursor above may be obtained by a coprecipitation method using an ion source that can form a precipitation with a transition metal ion in an aqueous solution and a transition metal compound comprising at least one element among Mn, Ni, and Co. As a result, spherical particles as the precursor are easily obtained. An “ion source that can form a precipitation with a transition metal ion in an aqueous solution”, for example, may be at least one selected from sodium salts such as sodium carbonate and sodium nitrate, sodium hydroxide, and sodium oxide. The transition metal compound may be a salt or hydroxide described above comprising at least one element among Mn, Ni, and Co. Specifically, in S1, the ion source and the transition metal compound may each be formed into a solution, and the solutions may then be dropped and mixed to obtain a precipitate as the precursor. In this case, for example, water is used as a solvent. In this case, various sodium compounds may be used as a base, and an ammonia aqueous solution may be added to adjust basicity. In the case of a coprecipitation method, the precipitate as the precursor is obtained, for example, by preparing an aqueous solution of a transition metal compound and an aqueous solution of sodium carbonate and dropping each to mix the aqueous solutions. Alternatively, it is possible to obtain the precursor by a sol-gel method. Particularly, according to the coprecipitation method, spherical particles as the precursor are easily obtained.

In S1, the precursor may comprise an element M. The element M is at least one selected from B, Mg, Al, K, Ca, Ti, V, Cr, Cu, Zn, Ga, Ge, Sr, Y, Zr, Nb, Mo, and W. These elements M, for example, have a function of stabilizing a P2-type structure and an O2-type structure. The method of obtaining a precursor comprising an element M is not particularly limited. When a precursor is obtained by a coprecipitation method in Si, for example, an aqueous solution of a transition metal compound comprising at least one of Mn, Ni, and Co, an aqueous solution of sodium carbonate, and an aqueous solution of a compound of the element M are prepared, the aqueous solutions are each added dropwise and mixed, whereby a precursor comprising at least one element among Mn, Ni, and Co and the element M is obtained. Alternatively, in the manufacturing method of the present disclosure, the element M is not added in S1, and the element M may be doped when carrying out a Na-doping firing in S2 and S3 described below.

In S2, the surface of the precursor obtained via S1 is covered with a Na source to obtain a composite. The Na source may be a salt comprising Na, such as a carbonate or a nitrate, or may be a compound other than a salt, such as sodium oxide or sodium hydroxide. In S2, the amount of the Na source for covering the surface of the precursor may be determined by taking into account the amount of Na lost during subsequent firing.

In S2, the coverage of a Na source relative to the surface of the precursor is not particularly limited. For example, in S2, the above composite may be obtained by covering 40% by area or greater, 50% by area or greater, 60% by area or greater, or 70% by area or greater of the surface of the above precursor with a Na source. When the precursor obtained via S1 consists of spherical particles, and the composite obtained via S2 is obtained by covering 40% by area or greater of the surface of the precursor with the Na source, a Na-containing oxide having a P2-type structure is easily formed into spherical particles in S3 described below. When the coverage of the Na source is small, P2-type crystals easily grow on the surface of the composite when the composite is fired, and a tabular Na-containing oxide is easily obtained. When the coverage of the Na source is large, small P2-type crystal crystallites are easily formed when the composite is fired, and the Na-containing oxide is easily formed into spherical particles corresponding to the shape of the precursor.

In S2, the method of covering the surface of the above precursor with a Na source is not particularly limited. As stated above, when covering 40% by area or greater of the surface of the precursor with a Na source, the method thereof includes various methods. For example, the method includes a rolling fluidized coating method and a spray drying method. Specifically, a coating solution in which a Na source is dissolved is prepared, the coating solution is brought into contact with the surface of the precursor, and simultaneously or subsequently dried. By adjusting the conditions (such as temperature, time, and number of times) of coating, 40% by area or greater of the surface of the precursor can be covered with a Na source.

In S2, the precursor may be covered with a Na source and an M source. For example, in S2, the precursor obtained via Si, a Na source, and an M source comprising at least one element selected from B, Mg, Al, K, Ca, Ti, V, Cr, Cu, Zn, Ga, Ge, Sr, Y, Zr, Nb, Mo, and W may be mixed to obtain a composite. The M source, for example, may be a salt comprising an element M, such as a carbonate or a sulfate, or may be a compound other than a salt, such as an oxide or a hydroxide. The amount of the M source relative to the precursor may be determined in accordance with the chemical composition of the Na-containing oxide after firing.

In S3, the composite obtained via S2 is fired to obtain a Na-containing oxide having a P2-type structure. S3 comprises the above S3-1, S3-2, and S3-3.

In S3-1, the composite is subjected to a pre-firing at a temperature of 300° C. or higher and lower than 700° C. for 2 h or more and 10 h or less. In S3-1, the pre-firing may be carried out after optionally molding the above composite. The pre-firing is carried out at a temperature lower than that of main firing. When the pre-firing in S3-1 is insufficient, it is possible that generation of a P2 phase in the ultimately obtained Na-containing oxide is insufficient. In S3-1, by setting the pre-firing temperature to 300° C. or higher and lower than 700° C. and the pre-firing time to 2 h or more and 10 h or less, the composite can be subjected to a sufficient pre-firing, heat uniformity is improved, and the Na-containing oxide obtained via S3-2 and S3-3 described below is likely a suitable one. The pre-firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. The pre-firing time may be 2 h or more and 8 h or less, 3 h or more and 8 h or less, 4 h or more and 8 h or less, 5 h or more and 8 h or less, or 5 h or more and 7 h or less. The pre-firing atmosphere is not particularly limited, and for example, may be an oxygen-containing atmosphere.

In S3-2, following the above pre-firing, the composite is subjected to a main firing at a temperature of 700° C. or higher and 1100° C. or lower for 30 min or more and 10 h or less. In S3-2, the main firing temperature of the composite is 700° C. or higher and 1100° C. or lower, and preferably 800° C. or higher and 1000° C. or lower. When the main firing temperature is too low, a P2 phase is not generated, and when the main firing temperature is too high, an 03 phase, not a P2 phase, is easily generated. The heating conditions from the pre-firing temperature to the main firing temperature are not particularly limited. The main firing time is not particularly limited, and for example, may be 30 min or more and 48 h or less. However, the shape of the Na-containing oxide can be controlled by the main firing time. As stated above, in the method of the present disclosure, when the coverage of a Na source on the composite is 40% by area or greater, small P2-type crystal crystallites are easily formed on the surface thereof when the composite is fired. In the method of the present disclosure, the shape of the Na-containing oxide corresponds to the shape of the precursor by growing P2-type crystals along the surfaces of particles so that one P2-type crystallite and another P2-type crystallite are connected to each other. For example, when the precursor consists of spherical particles, the Na-containing oxide can be formed into spherical particles. When the main firing time is too short, generation of a P2 phase is insufficient. When the main firing time is too long, the P2-type structure grows excessively and tabular, not spherical, particles are formed. As far as the present inventors have confirmed, when the main firing time is 30 min or more and 3 h or less, spherical particles of the Na-containing oxide are easily obtained. The Na-containing oxide obtained after the main firing may have a structure in which a plurality of crystallites are present on the surface and the crystallites are connected to each other.

In S3-3, following the above main firing, the composite undergoes rapid cooling (cooled at a cooling rate of 20° C./min or higher) from a temperature T₁ of 200° C. or higher to a temperature T₂ of 100° C. or lower. The above pre-firing and main firing are carried out in, for example, a heating furnace. In the step S3-3, for example, the composite is subjected to a main firing in a heating furnace and then cooled to an arbitrary temperature T₁ of 200° C. or higher in the heating furnace, and after reaching the temperature Ti, the fired product is removed from the heating furnace and undergoes rapid cooling outside the furnace to an arbitrary temperature T₂ of 100° C. or lower. The temperature T₁ is an arbitrary temperature of 200° C. or higher, and may be an arbitrary temperature of 250° C. or higher. The temperature T₂ is an arbitrary temperature of 100° C. or lower, and may be an arbitrary temperature of 50° C. or lower or may be the cooling end temperature. In the predetermined temperature region from the temperature T₁ until reaching the temperature T₂, moisture easily infiltrates between layers of a P2-type structure by atomic vibrations or molecular motion. When cooling the composite (Na-containing oxide having a P2-type structure) after main firing, by shortening the time in the temperature region where such moisture easily infiltrates (i.e., rapid cooling), it is considered that the infiltration amount of moisture between layers of the P2-type structure is decreased. In this regard, in the step S3-3, when cooling the composite after the main firing, by leaving the composite particles to cool from an arbitrary temperature T₁ of 200° C. or higher until reaching an arbitrary temperature T₂ of 100° C. or lower in, for example, a dry atmosphere outside the furnace, the cooling rate from the temperature T₁ to the temperature T₂ is rapid (for example, 20° C./min or higher), moisture does not easily infiltrate between layers of the P2-type structure, and collapse of the P2-type structure can be inhibited. As a result, Na can efficiently undergo ion exchange with Li in S4.

A Na-containing oxide having a P2-type structure and having a predetermined chemical composition can be manufactured via S3. The Na-containing oxide at least comprises, as constituent elements, at least one transition metal element among Mn, Ni, and Co; Na; and O. Particularly, when the constituent elements at least include Na, Mn, at least one of Ni and Co, and O, especially when the constituent elements include at least Na, Mn, Ni, Co, and O, performance of the positive electrode active material is easily increased. The Na-containing oxide may have a chemical composition represented by Na_{c}Mnₓ₋ₚNi_{y-q}Co_{z-r}M_{p+q+r}O₂, where 0<c<1.00, x+y+z=1, and 0≤p+q+r<0.17. In addition, M is at least one element selected from B, Mg, Al, K, Ca, Ti, V, Cr, Fe, Cu, Zn, Ga, Ge, Sr, Y, Zr, Nb, Mo, and W. When the Na-containing oxide has such a chemical composition, a P2-type structure is more easily maintained. In the above chemical composition, c is greater than 0 and may be 0.10 or greater, 0.20 or greater, 0.30 or greater, 0.40 or greater, 0.50 or greater, or 0.60 or greater, and is less than 1.00 and may be 0.90 or less, 0.80 or less, or 0.70 or less. x is 0 or greater and may be 0.10 or greater, 0.20 or greater, 0.30 or greater, 0.40 or greater, or 0.50 or greater, and is 1.00 or less and may be 0.90 or less, 0.80 or less, 0.70 or less, 0.60 or less, or 0.50 or less. y is 0 or greater and may be 0.10 or greater or 0.20 or greater, and is 1.00 or less and may be 0.90 or less, 0.80 or less, 0.70 or less, 0.60 or less, 0.50 or less, 0.40 or less, 0.30 or less, or 0.20 or less. z is 0 or greater and may be 0.10 or greater, 0.20 or greater, or 0.30 or greater, and is 1.00 or less and may be 0.90 or less, 0.80 or less, 0.70 or less, 0.60 or less, 0.50 or less, 0.40 or less, or 0.30 or less. The element M has a small contribution towards charging and discharging. In this regard, in the above chemical composition, by having p+q+r less than 0.17, high charge and discharge capacities are easily ensured. p+q+r may be 0.16 or less, 0.15 or less, 0.14 or less, 0.13 or less, 0.12 or less, 0.11 or less, or 0.10 or less. By including the element M, P2-type and O2-type structures are easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but may be variable without being limited to exactly 2.0.

In S4, by subjecting at least a portion of Na in the Na-containing oxide obtained via S3 to ion exchange with Li, a Li-containing oxide having a Li-deficient O2-type structure is obtained. Ion exchange includes, for example, a method using an aqueous solution comprising a lithium halide and a method using a mixture (for example, a molten salt) of a lithium halide and an additional lithium salt. From the viewpoint that a P2-type structure is easily broken by water infiltration and the viewpoint of crystallinity, of the above two methods, a method using a molten salt is preferable. Specifically, the above Na-containing oxide having a P2-type structure and the molten salt are mixed and heated to a temperature of the melting point of the molten salt or higher, whereby at least a portion of Na in the Na-containing oxide can be substituted with Li by ion exchange. The lithium halide constituting the molten salt is preferably at least one of lithium chloride, lithium bromide, and lithium iodide. An additional lithium salt constituting the molten salt is preferably lithium nitrate. By using a molten salt, the melting point is lowered compared to when the lithium halide and the additional lithium salt are used independently, and ion exchange at a lower temperature is possible. The temperature of the ion exchange, for example, may be the melting point of the above molten salt or higher and 600° C. or lower, 500° C. or lower, 400° C. or lower, or 300° C. or lower. When the temperature of the ion exchange is too high, an O3-type structure, which is a stable phase, not an O2-type structure, is easily generated. From the viewpoint of shortening the time required for the ion exchange, the temperature of the ion exchange is preferably as high as possible.

### 1.1.1.6 Protective Layer

A protective layer having ion-conducting properties may be formed on the surface of the positive electrode active material having a Li-deficient O2-type structure. Specifically, the positive electrode active material layer 10 may comprise a composite of the positive electrode active material and a protective layer. At least a portion of the surface of the positive electrode active material in the composite may be covered by the protective layer. According to the findings of the present inventors, even when a protective layer is formed on the surface of the positive electrode active material having a Li-deficient O2-type structure, the reaction between the positive electrode active material and a sulfide solid electrolyte may not be suppressed. As described below, in the present disclosure, by controlling the pressing temperature of the positive electrode active material layer, the reaction between the positive electrode active material and a sulfide solid electrolyte is suppressed.

The protective layer having ion-conducting properties can include various ion-conducting compounds. The ion-conducting compound, for example, may be at least one selected from an ion-conducting oxide and an ion-conducting halide.

The ion-conducting oxide, for example, may comprise at least one element selected from B, C, Al, Si, P, S, Ti, La, Zr, Nb, Mo, Zn, and W; Li; and O. The ion-conducting oxide may be an oxynitride comprising N. More specifically, the ion-conducting oxide may be at least one selected from Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, LiPON, Li₂O—LaO₂, and Li₂O—ZnO₂. The ion-conducting oxide may have a portion of elements substituted by various doping elements.

The ion-conducting halide, for example, may be at least one of various compounds exemplified as a halide solid electrolyte described below. The ion-conducting halide, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm; at least one halogen element selected from the group consisting of Cl, Br, I, and F; and Li. The ion-conducting halide may comprise at least one selected from the group consisting of Ti, Al, Gd, Ca, Zr, and Y; at least one selected from the group consisting of Cl, Br, I, and F; and Li. The ion-conducting halide may comprise at least one element selected from the group consisting of Ti and Al; at least one element selected from the group consisting of Cl, Br, I, and F; and Li. The ion-conducting halide, for example, may be a composite halide of Li, Ti, Al, and F.

The coverage (area ratio) of the protective layer relative to the surface of the positive electrode active material, for example, may be 70% or greater, may be 80% or greater, or may be 90% or greater. The thickness of the protective layer, for example, may be 0.1 nm or more or 1 nm or more, and may be 100 nm or less or 20 nm or less.

### 1.1.2 Sulfide Solid Electrolyte

The positive electrode active material layer 10 comprises the above positive electrode active material having a Li-deficient O2-type structure and a sulfide solid electrolyte. The manufacturing method of the sulfide solid electrolyte is known. Specifically, the desired sulfide solid electrolyte can be manufactured through selecting and weighing raw materials according to a target chemical composition, and then mixing the raw materials.

### 1.1.2.1 Crystallinity

The sulfide solid electrolyte may be a glass-based sulfide solid electrolyte (sulfide glass), may be a glass-ceramic-based sulfide solid electrolyte, or may be a crystal-based sulfide solid electrolyte. The sulfide glass is amorphous. The sulfide glass may have a glass transition temperature (Tg). When the sulfide solid electrolyte has a crystal phase, examples of the crystal phase include Thio-LISICON-type crystal phase, LGPS-type crystal phase, and argyrodite-type crystal phase.

### 1.1.2.2 Chemical Composition

The sulfide solid electrolyte, for example, can contain Li element, P element, and S element. The sulfide solid electrolyte may further contain an X element (X is at least one of As, Sb, Si, Ge, Sn, B, Al, Ga, and In). In addition, the sulfide solid electrolyte may further contain at least one of O element and a halogen element. Further, the sulfide solid electrolyte may contain S element as an anionic element main component. The sulfide solid electrolyte, for example, may be at least one selected from Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂—P₂S₅—LiI, Li₂S—P₂S₅—ZₘSₙ (where m and n are positive numbers, and Z is any of Ge, Zn, and Ga), Li₂S—SiS₂—Li₃PO₄, and Li₂S—SiS₂—LiₓMO_{y} (where x and y are positive numbers, and M is P and optionally any of Si, Ge, B, Al, Ga, and In). Alternatively, the sulfide solid electrolyte is not particularly limited, and for example, may have at least one chemical composition selected from xLi₂S·(100−x)P₂S₅ (70≤x≤80) and yLiI·zLiBr·(100−y−z)(xLi₂S·(1−x)P₂S₅) (0.7≤x≤0.8, 0≤y≤30, and 0≤z≤30).

Alternatively, the sulfide solid electrolyte may have a chemical composition represented by general formula: Li₄₋ₓGe₁₋ₓPₓS₄ (0<x<1). In the above general formula, at least a portion of Ge may be substituted with at least one of Sb, Si, Sn, B, Al, Ga, In, Ti, Zr, V, and Nb. In the above general formula, a portion of P may be substituted with at least one of Sb, Si, Sn, B, Al, Ga, In, Ti, Zr, V, and Nb. In the above general formula, a portion of Li may be substituted with at least one of Na, K, Mg, Ca, and Zn. In the above general formula, a portion of S may be substituted with a halogen (at least one of F, Cl, Br, and I). Alternatively, the sulfide solid electrolyte may have a chemical composition represented by Li₇₋ₐPS₆₋ₐXₐ (X is at least one of Cl, Br, and I, and a is a number of 0 or greater and 2 or less). a may be 0, or may be greater than 0. In the latter case, a may be 0.1 or greater, may be 0.5 or greater, or may be 1 or greater. In addition, a may be 1.8 or less, or may be 1.5 or less.

### 1.1.2.3 Shape

The sulfide solid electrolyte may be particulate. The average particle size (D50) of the sulfide solid electrolyte, for example, may be 10 nm or more and 100 μm or less.

### 1.1.3. Additional Components

The positive electrode active material layer 10 may optionally comprise an additional positive electrode active material, an additional electrolyte, a conductive aid, and a binder.

### 1.1.3.1 Additional Positive Electrode Active Material

The positive electrode active material contained in the positive electrode active material layer 10 may consist only of the above positive electrode active material having a Li-deficient O2-type structure, or may comprise the positive electrode active material and another positive electrode active material (additional positive electrode active material). From the viewpoint of further enhancing the effect of the technique of the present disclosure, the proportion of the additional positive electrode active material to the entirety of the positive electrode active material may be a small amount. For example, when the entirety of the positive electrode active material is 100% by mass, the content of the above positive electrode active material having a Li-deficient O2-type structure may be 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

For the additional positive electrode active material that can be contained in the positive electrode active material layer 10, any known positive electrode active material for lithium-ion batteries can be adopted. The additional positive electrode active material may be at least one selected from various lithium compounds other than the above Li-containing oxide having a Li-deficient O2-type structure, elemental sulfur, and sulfur compounds. The lithium compound as the additional positive electrode active material may be a Li-containing oxide comprising at least one element M; Li; and O. The element M, for example, may be at least one selected from Mn, Ni, Co, Al, Mg, Ca, Sc, V, Cr, Cu, Zn, Ga, Ge, Y, Zr, Sn, Sb, W, Pb, Bi, Fe, and Ti, or may be at least one selected from the group consisting of Mn, Ni, Co, Al, Fe, and Ti. More specifically, the Li-containing oxide as the additional positive electrode active material may be at least one selected from lithium cobaltate, lithium nickelate, lithium manganate, lithium nickel cobaltate, lithium nickel manganate, lithium cobalt manganate, lithium nickel-cobalt-manganese oxide (Li_{1±α}NiₓCo_{y}Mn_{z}O_{2±δ} (for example, 0<x<1, 0<y<1, 0<z<1, and x+y+z=1)), spinel-based lithium compounds (heteroelement-substituted Li—Mn spinels having a composition represented by Li₁₊ₓMn_{2-x-y}M_{y}O₄ (M is one or more selected from Al, Mg, Co, Fe, Ni, and Zn)), lithium nickel-cobalt-aluminum oxide (for example, Li_{1±α}NiₚCo_{q}AlᵣO2±δ (for example, p+q+r=1)), lithium titanate, and lithium metal phosphate (such as LiMPO₄; M is one or more selected from Fe, Mn, Co, and Ni). Particularly, when the additional positive electrode active material comprises a Li-containing oxide at least comprising, as constituent elements, at least one of Ni, Co, and Mn; Li; and O, performance of the lithium-ion battery is easily further enhanced. Alternatively, when the additional positive electrode active material comprises a Li-containing oxide at least comprising, as constituent elements, at least one of Ni, Co, and Al; Li; and O, performance of the lithium-ion battery is easily further enhanced. The additional positive electrode active material may be of one type used alone, or may be of two or more types used in combination. The shape of the additional positive electrode active material needs only to be any of general shapes of positive electrode active materials for lithium-ion batteries. The additional positive electrode active material, for example, may be particulate. The additional positive electrode active material may be solid, may have voids therein, for example, may be porous, or may be hollow. The additional positive electrode active material may be of primary particles, or may be of secondary particles of a plurality of agglomerated primary particles. The average particle size D50 of the additional positive electrode active material, for example, may be 1 nm or more, 5 nm or more, or 10 nm or more, and may be 500 μm or less, 100 μm or less, 50 μm or less, or 30 μm or less.

### 1.1.3.2 Additional Electrolyte

The electrolyte contained in the positive electrode active material layer 10 may consist only of the above sulfide solid electrolyte, or may comprise the sulfide solid electrolyte and another electrolyte (additional electrolyte). From the viewpoint of further enhancing the effect of the technique of the present disclosure, the proportion of the additional electrolyte to the entirety of the electrolyte contained in the positive electrode active material layer 10 may be a small amount. For example, when the entirety of the electrolyte contained in the positive electrode active material layer 10 is 100% by mass, the content of the above sulfide solid electrolyte may be 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

The additional electrolyte that can be contained in the positive electrode active material layer 10 may be a solid electrolyte, may be a liquid electrolyte, or may be a combination thereof. The solid electrolyte needs only to be a known solid electrolyte used as a solid electrolyte for lithium-ion batteries. The solid electrolyte may be an inorganic solid electrolyte or an organic polymer electrolyte. Particularly, an inorganic solid electrolyte has excellent ion-conducting properties and heat resistance. Examples of an inorganic solid electrolyte other than the above sulfide solid electrolyte include oxide solid electrolytes and inorganic solid electrolytes having ion-binding properties. Among solid electrolytes having ion-binding properties, solid electrolytes comprising, as constituent elements, at least Li, Y, and a halogen (at least one of Cl, Br, I, and F) have high performance. The additional solid electrolyte may be amorphous, or may be crystalline. The additional solid electrolyte may be particulate. The average particle size (D50) of the additional solid electrolyte, for example, may be 10 nm or more and 10 μm or less. The solid electrolyte may be of one type used alone, or may be of two or more types used in combination.

The oxide solid electrolyte may be one or more selected from lithium lanthanum zirconate, LiPON, Li₁₊ₓAlₓGe₂₋ₓ(PO₄)₃, Li—SiO-based glass, and Li—Al—S—O-based glass. When an oxide solid electrolyte and a liquid electrolyte are combined, ion-conducting properties can be improved.

The solid electrolyte having ion-binding properties, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm. These elements can generate cations in water. The ion-binding solid electrolyte material, for example, may comprise at least one halogen element selected from the group consisting of Cl, Br, I, and F. These elements can generate anions in water. The solid electrolyte having ion-binding properties may comprise at least one selected from the group consisting of Gd, Ca, Zr, and Y, at least one selected from the group consisting of Cl, Br, I, and F, and Li. The solid electrolyte having ion-binding properties comprises Li and Y, and may comprise at least one selected from the group consisting of Cl, Br, I, and F. More specifically, the solid electrolyte having ion-binding properties may comprise Li, Y, Cl, and Br, may comprise Li, Ca, Y, Gd, Cl, and Br, or may comprise Li, Zr, Y, and Cl. Even more specifically, the solid electrolyte having ion-binding properties may be at least one of Li₃YBr₂Cl₄, Li_{2.8}Ca_{0.1}Y_{0.5}Gd_{0.5}Br₂Cl₄, and Li_{2.5}Y_{0.5}Zr_{0.5}Cl₆.

The solid electrolyte having ion-binding properties may be a halide solid electrolyte. A halide solid electrolyte has excellent ion-conducting properties. The halide solid electrolyte may have a composition represented by, for example, formula (A):

Li_{α}M_{β}X_{γ} (A)

where α, β, and γ are each independently a value greater than 0, M is at least one selected from the group consisting of metal elements other than Li and semimetal elements, and X is at least one selected from the group consisting of Cl, Br, and I. Note that a “semimetal element” may be at least one selected from the group consisting of B, Si, Ge, As, Sb, and Te. Further, a “metal element” may include (i) all of the elements contained from Group 1 to Group 12 of the periodic table (excluding hydrogen) and (ii) all of the elements contained from Group 13 to Group 16 of the periodic table (excluding B, Si, Ge, As, Sb, Te, C, N, P, O, S, and Se). A metal element can form an inorganic compound with halide ions and form cations.

In the formula (A), M may comprise Y (i.e., yttrium). A halide solid electrolyte comprising Y may have a composition represented by LiₐMe_{b}Y_{c}X₆ (where a+mb+3c=6, c>0, Me is at least one selected from the group consisting of metal elements and semimetal elements other than Li and Y, and m is the valence of Me). Me, for example, may be at least one selected from the group consisting of Mg, Ca, Sr, Ba, Zn, Sc, Al, Ga, Bi, Zr, Hf, Ti, Sn, Ta, and Nb.

The halide solid electrolyte may have a composition represented by formula (A1): Li_{6-3d}Y_{d}X₆. In the formula (A1), X is one or more elements selected from the group consisting of Cl, Br, and I. d may satisfy 0<d<2, or may be d=1. The halide solid electrolyte may have a composition represented by formula (A2): Li_{3-3δ}Y_{1+δ}Cl₆. In the formula (A2), δ may be 0<δ≤0.15. The halide solid electrolyte may have a composition represented by formula (A3): Li_{3-3δ}Y_{1+δ}Br₆. In the formula (A3), δ may be 0<δ≤0.25. The halide solid electrolyte may have a composition represented by formula (A4): Li_{3-3δ+α}Y_{1+δ-a}MeₐCl_{6-x-y}BrₓI_{y}. In the formula (A4), Me may be at least one selected from the group consisting of Mg, Ca, Sr, Ba, and Zn. In the formula (A4), for example, −1<δ<2, 0<a<3, 0<(3−3δ+a), 0<(1+δ−a), 0≤x≤6, 0≤y≤6, and (x+y)≤6 are satisfied. The halide solid electrolyte may have a composition represented by formula (A5): Li_{3-3δ}Y_{1+δ-a}MeₐCl_{6-x-y}BrₓI_{y}. In the formula (A5), Me may be at least one selected from the group consisting of A1, Sc, Ga, and Bi. In the formula (A5), the variables may satisfy −i<δ<1, 0<a<2, 0<(1+δ−a), 0≤x≤6, 0≤y≤6, and (x+y)≤6. The halide solid electrolyte may have a composition represented by formula (A6): Li_{3-3δ-α}Y_{1+δ-a}MeₐCl_{6-x-y}BrₓI_{y}. In the formula (A6), Me may be at least one selected from the group consisting of Zr, Hf, and Ti. In the formula (A6), the variables may satisfy −1<δ<1, 0<a<1.5, 0<(3−3δ−a), 0<(1+δ−a), 0≤x≤6, 0≤y≤6, and (x+y)≤6. The halide solid electrolyte may have a composition represented by formula (A7): Li_{3-3δ-2a}Y_{1+δ-a}MeₐCl_{6-x-y}BrₓI_{y}. In the formula (A7), Me may be at least one selected from the group consisting of Ta and Nb. In the formula (A7), the variables may satisfy −1<δ<1, 0<a<1.2, 0<(3−3δ−2a), 0<(1+δ−a), 0≤x≤6, 0≤y≤6, and (x+y)≤6.

The solid electrolyte having ion-binding properties may be a complex hydride solid electrolyte. The complex hydride solid electrolyte can be composed of Li ions and complex ions comprising H. The complex ion comprising H, for example, may comprise an element M comprising at least one of nonmetal elements, semimetal elements, and metal elements and H bonded to the element M. In the complex ion comprising H, an element M as a central element and H surrounding the element M may be bonded to each other via a covalent bond. The complex ion comprising H may be represented by (MₘHₙ)^{α}. In this case, m can be any positive number, and n and a can take on any positive number depending on m and the valence of the element M. The element M needs only to be any nonmetal element or metal element that can form a complex ion. For example, the element M may comprise at least one of B, C, and N as a nonmetal element, or may comprise B. Further, for example, the element M may comprise at least one of A1, Ni, and Fe as a metal element. Particularly, when the complex ion comprises B or comprises C and B, higher ion-conducting properties are easily ensured. Specific examples of the complex ion comprising H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. Particularly, when (CB₉H₁₀)⁻, (CB₁₁H₁₂)⁻, or a combination thereof is used, higher ion-conducting properties are easily ensured. Specifically, the complex hydride solid electrolyte may comprise Li, C, B, and H.

The liquid electrolyte is a liquid comprising lithium ions as carrier ions. The electrolyte solution may be a water-based electrolyte solution or a non-water-based electrolyte solution. The composition of the electrolyte solution needs only to be the same as any known electrolyte solution for lithium-ion batteries. The electrolyte solution may be water or a non-water-based solvent dissolving a lithium salt. Examples of the non-water-based solvent include various carbonate-based solvents. Examples of the lithium salt include lithium amide and LiPF₆.

### 1.1.3.3 Conductive Aid

Examples of the conductive aid that can be contained in the positive electrode active material layer 10 include carbon materials such as vapor-grown carbon fiber (VGCF), acetylene black (AB), ketjen black (KB), carbon nanotube (CNT), and carbon nanofiber (CNF); and metal materials such as nickel, titanium, aluminum, and stainless steel. The conductive aid, for example, may be particulate or fibrous, and the size thereof is not particularly limited. The conductive aid may be of one type used alone, or may be of two or more types used in combination.

### 1.1.3.4 Binder

Examples of the binder that can be contained in the positive electrode active material layer 10 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 1.1.3.5 Others

The positive electrode active material layer 10 may comprise various additives, in addition to the above components, for example, a dispersant or a lubricant.

### 1.1.4 Raman Spectrum of Positive Electrode Active Material Layer

A Raman spectrum of the positive electrode active material layer 10 satisfies relationships (1) and (2) below.

$${I}_{R 1} / {I}_{R 2} \leq 0.2 ; \qquad ( 1 )$$

$${I}_{R 3} / {I}_{R 2} \leq 0.2 ; \qquad ( 2 )$$

I_{R1}: peak intensity from P₂S₆⁴⁻ in the Raman spectrum
I_{R2}: peak intensity from PS₄³⁻ in the Raman spectrum
I_{R3}: peak intensity from S—S in the Raman spectrum

Peak intensity I_{R1} corresponds to a peak intensity at 385 cm⁻¹ in the Raman spectrum. Peak intensity I_{R2} corresponds to a peak intensity at 420 cm⁻¹ in the Raman spectrum. Peak intensity I_{R3} corresponds to a peak intensity at 475 cm⁻¹ in the Raman spectrum. Note that the Raman spectrum is normalized (background-processed) with a peak intensity at 300 cm⁻¹ as 0.

In the prior art, when obtaining a positive electrode active material layer, pressing is carried out at as high a temperature as possible to improve the density of the positive electrode active material layer, thereby lowering the resistance of the positive electrode active material layer. However, according to new findings of the present inventors, in the case of a positive electrode active material layer comprising a positive electrode active material having a Li-deficient O2-type structure and a sulfide solid electrolyte, when the positive electrode active material layer is pressed at high temperature, the positive electrode active material having a Li-deficient O2-type structure and the sulfide solid electrolyte react, causing the PS₄ skeleton of the sulfide solid electrolyte to collapse and instead increasing resistance. Such a problem specifically occurs when a positive electrode active material having a Li-deficient O2-type structure and a sulfide solid electrolyte are combined in a positive electrode active material layer. When a non-Li-deficient positive electrode active material (for example, a positive electrode active material having an O2-type structure doped with Li, or a positive electrode active material having an O₃-type structure) and a sulfide solid electrolyte are combined, such a problem does not occur.

According to new findings of the present inventors, when the PS₄ skeleton of a sulfide solid electrolyte contained in the positive electrode active material layer collapses, peaks from reaction products such as P₂S₆⁴⁻ and S—S are confirmed by acquiring a Raman spectrum of the positive electrode active material layer. It can be said that the smaller the Raman peaks of such reaction products, the more the PS₄ skeleton of the sulfide solid electrolyte contained in the positive electrode active material layer can be maintained, and the more the reaction between the positive electrode active material having a Li-deficient O2-type structure and the sulfide solid electrolyte is suppressed.

According to new findings of the present inventors, when a Raman spectrum of the positive electrode active material layer 10 is acquired, if the peak intensity ratio I_{R1}/I_{R2} is 0.20 or less and the peak intensity ratio I_{R3}/I_{R2} is 0.20 or less, it can be said that the PS₄ skeleton of the sulfide solid electrolyte in the positive electrode active material layer 10 is suitably maintained, and low resistance can be maintained. The peak intensity ratio I_{R1}/I_{R2} may be 0.15 or less, 0.10 or less, or 0.05 or less. The peak intensity ratio I_{R3}/I_{R2} may be 0.15 or less, 0.10 or less, or 0.05 or less. Particularly, when the peak intensity ratio I_{R1}/I_{R2} is 0.10 or less and the peak intensity ratio I_{R3}/I_{R2} is 0.10 or less, a more significant resistance-lowering effect is easily obtained. The lower limit of each of the peak intensity ratio I_{R1}/I_{R2} and the peak intensity ratio I_{R3}/I_{R2} is not particularly limited, and each is 0 or greater and may be 0.01 or greater.

### 1.1.5 XPS Spectrum of Positive Electrode Active Material Layer

An XPS spectrum of the positive electrode active material layer 10 may satisfy relationships (3) and (4) below.

$${I}_{X 1} / {I}_{X 2} \leq 1.2 ; \qquad ( 3 )$$

$${I}_{X 3} / {I}_{X 4} \leq 1.6 ; \qquad ( 4 )$$

I_{X1}: peak intensity from P—S—P in the XPS spectrum for S2p;
I_{X2}: peak intensity from PS₄³⁻ in the XPS spectrum for S2p;
I_{X3}: peak intensity from POₓS₄₋ₓ³⁻ in the XPS spectrum for P2p;
I_{X4}: peak intensity from PS₄³⁻ in the XPS spectrum for P2p.

Peak intensity ratio I_{X1}/I_{X2} corresponds to a ratio I_{X1}/I_{X2} of a peak intensity I_{X1} at 162.9 eV in the XPS spectrum for S2p to a peak intensity I_{X2} at 161.6 eV in the XPS spectrum for S2p. Peak intensity ratio I_{X3}/I_{X4} corresponds to a ratio I_{X3}/I_{X4} of a peak intensity I_{X3} at 133.6 eV in the XPS spectrum for P2p to a peak intensity I_{X4} at 132.2 eV in the XPS spectrum for P2p. Note that, the XPS spectrum is normalized (background-processed) with peak intensities at 138 eV and 170 eV as 0.

According to new findings of the present inventors, when the PS₄ skeleton of a sulfide solid electrolyte in the positive electrode active material layer collapses due to the mechanism stated above, peaks from reaction products such as P—S—P and POₓS₄₋ₓ³⁻ are confirmed by acquiring an XPS spectrum of the positive electrode active material layer. It can be said that the smaller the XPS peaks of such reaction products, the more the PS₄ skeleton of the sulfide solid electrolyte contained in the positive electrode active material layer can be maintained, and the more the reaction between the positive electrode active material having a Li-deficient O2-type structure and the sulfide solid electrolyte is suppressed.

According to new findings of the present inventors, when an XPS spectrum of the positive electrode active material layer 10 is acquired, if the peak intensity ratio I_{X1}/I_{X2} is 1.20 or less and the peak intensity ratio I_{X3}/I_{X4} is 1.60 or less, it can be said that the PS₄ skeleton of the sulfide solid electrolyte in the positive electrode active material layer 10 is more suitably maintained, and a lower resistance can be maintained. The peak intensity ratio I_{X1}/I_{X2} may be 1.10 or less, 1.00 or less, 0.90 or less, 0.80 or less, 0.70 or less, or 0.60 or less. The peak intensity ratio I_{X3}/I_{X4} may be 1.40 or less, 1.20 or less, 1.00 or less, 0.80 or less, 0.60 or less, or 0.40 or less. Particularly, when the peak intensity ratio I_{X1}/I_{X2} is 0.70 or less and the peak intensity ratio I_{X3}/I_{X4} is 0.50 or less, a more significant resistance-lowering effect is easily obtained. The lower limit of each of the peak intensity ratio I_{X1}/I_{X2} and the peak intensity ratio I_{X3}/I_{X4} is not particularly limited, and each is 0 or greater. The peak intensity ratio I_{X1}/I_{X2} may be 0.10 or greater, 0.20 or greater, 0.30 or greater, 0.40 or greater, or 0.50 or greater. The peak intensity ratio I_{X3}/I_{X4} may be 0.10 or greater, 0.20 or greater, or 0.30 or greater.

1.1.6 Shape of Positive Electrode Active Material Layer The shape of the positive electrode active material layer 10 is not particularly limited, and for example, may be a sheet-like positive electrode active material layer 10 having a substantially flat surface. The thickness of the positive electrode active material layer 10 is not particularly limited, and for example, may be 0.1 μm or more or 1 μm or more, and may be 2 mm or less or 1 mm or less.

### 1.2 Electrolyte Layer

The electrolyte layer 20 is arranged between the positive electrode active material layer 10 and the negative electrode active material layer 30. The electrolyte layer 20 comprises at least an electrolyte. The electrolyte layer 20 may comprise at least one of a solid electrolyte and an electrolyte solution, and may further optionally comprise a binder. Particularly, when the electrolyte layer 20 comprises a solid electrolyte, higher performance is easily ensured. The contents of the electrolyte and the binder in the electrolyte layer 20 are not particularly limited. Alternatively, the electrolyte layer 20 may comprise a separator for retaining an electrolyte solution and preventing contact between the positive electrode active material layer 10 and the negative electrode active material layer 30. The thickness of the electrolyte layer 20 is not particularly limited, and for example, may be 0.1 μm or more or 1 μm or more, and may be 2 mm or more or 1 mm or less.

The electrolyte layer 20 may consist of one layer, or may consist of a plurality of layers. For example, the electrolyte layer 20 may be provided with a first layer arranged on the positive electrode active material layer 10 side and a second layer arranged on the negative electrode active material layer 30 side, wherein the first layer may comprise a first electrolyte and the second layer may comprise a second electrolyte. The first electrolyte and the second electrolyte may be of different types from each other. The first electrolyte and the second electrolyte may each be at least one selected from the above oxide solid electrolytes, sulfide solid electrolytes, and solid electrolytes having ion-binding properties. For example, the first layer may comprise a solid electrolyte having ion-binding properties, and the second layer may comprise at least one of a solid electrolyte having ion-binding properties and a sulfide solid electrolyte.

The electrolyte contained in the electrolyte layer 20 needs only to be appropriately selected from among ones (solid electrolytes and/or liquid electrolytes) exemplified as an electrolyte that can be contained in the positive electrode active material layer 10 described above. The binder that can be contained in the electrolyte layer 20 needs only to be appropriately selected from among ones exemplified as a binder that can be contained in the positive electrode active material layer described above. The electrolyte and the binder may each be of one type used alone, or may be of two or more types used in combination. The separator needs only to be a commonly used separator in lithium-ion batteries. Examples thereof include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose nonwoven fabric, resin nonwoven fabric, or glass-fiber nonwoven fabric.

### 1.3 Negative Electrode Active Material Layer

The negative electrode active material layer 30 comprises at least a negative electrode active material. The negative electrode active material layer 30 may optionally comprise an electrolyte, a conductive aid, a binder, and various additives. The content of each component in the negative electrode active material layer 30 needs only to be appropriately determined in accordance with the target battery performance. For example, when the entire solid content of the negative electrode active material layer 30 is 100% by mass, the content of the negative electrode active material may be 40% by mass or greater, 50% by mass or greater, 60% by mass or greater, or 70% by mass or greater, and may be 100% by mass or less, less than 100% by mass, 95% by mass or less, or 90% by mass or less. Alternatively, when the entire negative electrode active material layer 30 is 100% by volume, the negative electrode active material and optionally the electrolyte, conductive aid, and binder in total may be contained at 85% by volume or greater, 90% by volume or greater, or 95% by volume or greater, and the remaining portion may be voids or additional components. The shape of the negative electrode active material layer 30 is not particularly limited, and for example, may be a sheet having a substantially flat surface. The thickness of the negative electrode active material layer 30 is not particularly limited, and for example, may be 0.1 μm or more, 1 μm or more, 10 μm or more, or 30 μm or more, and may be 2 mm or less, 1 mm or less, 500 μm or less, or 100 μm or less.

### 1.3.1 Negative Electrode Active Material

Any known negative electrode active material for lithium-ion batteries can be adopted as the negative electrode active material. Of known active materials, various materials having a low electric potential (charge and discharge potentials) for storing and releasing lithium ions compared to the above positive electrode active material can be adopted. For example, silicon-based active materials such as Si, Si alloys, and silicon oxides; carbon-based active materials such as graphite and hard carbon; various oxide-based active materials such as lithium titanate; and metallic lithium and lithium alloys can be adopted. Of these, when the negative electrode active material layer 30 comprises Si as a negative electrode active material, performance of the lithium-ion battery 100 is easily enhanced. The negative electrode active material may be of one type used alone, or may be of two or more types used in combination. The shape of the negative electrode active material needs only to be any general shapes of negative electrode active materials for lithium-ion batteries. For example, the negative electrode active material may be particulate. The negative electrode active material particles may be primary particles, or may be secondary particles of a plurality of agglomerated primary particles. The average particle size (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 30 may consist of a sheet of negative electrode active material.

### 1.3.2 Others

The electrolyte that can be contained in the negative electrode active material layer 30, for example, includes the solid electrolytes and electrolyte solutions described above, and combinations thereof. The conductive aid that can be contained in the negative electrode active material layer 30, for example, needs only to be appropriately selected from among ones exemplified as a conductive aid that can be contained in the positive electrode active material layer described above. The binder that can be contained in the negative electrode active material layer 30, for example, needs only to be appropriately selected from among one exemplified as a binder that can be contained in the positive electrode active material layer described above. The electrolyte, the conductive aid, and the binder may each be of one type used alone, or may be of two or more types used in combination.

### 1.4 Positive Electrode Current Collector

As shown in FIG. 1, the lithium-ion battery 100 may be provided with a positive electrode current collector 40 in contact with the positive electrode active material layer 10. Any general positive electrode current collector for lithium-ion batteries can be adopted as the positive electrode current collector 40. The positive electrode current collector 40 may have at least one shape selected from foil-like, tabular, mesh-like, punched metal-like, and a foam. The positive electrode current collector 40 may be composed of a metal foil or a metal mesh. Particularly, a metal foil has excellent handleability. The positive electrode current collector 40 may consist of a plurality of foils. Examples of metals constituting the positive electrode current collector 40 include at least one selected from Cu, Ni, Cr, Au, Pt, Ag, Al, Fe, Ti, Zn, Co, V, Mg, Pg, Ge, In, Sn, Zr, and stainless steel. Particularly, from the viewpoint of ensuring oxidation resistance, the positive electrode current collector 40 may comprise A1. The positive electrode current collector 40 may have on the surface thereof some coating layer for the purpose of adjusting resistance. For example, the positive electrode current collector 40 may have a carbon coating layer. The positive electrode current collector 40 may be a metal foil or substrate plated or vapor-deposited with a metal described above. When the positive electrode current collector 40 consists of a plurality of metal foils, there may be some layer between the plurality of metal foils. The thickness of the positive electrode current collector 40 is not particularly limited, and for example, may be 0.1 μm or more or 1 μm or more, and may be 1 mm or less or 100 μm or less.

### 1.5 Negative Electrode Current Collector

As shown in FIG. 1, the lithium-ion battery 100 may be provided with a negative electrode current collector 50 in contact with the negative electrode active material layer 30. Any general negative electrode current collector for lithium-ion batteries can be adopted as the negative electrode current collector 50. The negative electrode current collector 50 may be foil-like, tabular, mesh-like, punched metal-like, or a foam. The negative electrode current collector 50 may be a metal foil or a metal mesh, and alternatively, may be a carbon sheet. Particularly, a metal foil has excellent handleability. The negative electrode current collector 50 may consist of a plurality of foils or sheets. Metals constituting the negative electrode current collector 50 include at least one selected from Cu, Ni, Cr, Au, Pt, Ag, Al, Fe, Ti, Zn, Co, V, Mg, Pb, Ge, In, Sn, Zr, and stainless steel. Particularly, from the viewpoint of ensuring reduction resistance and the viewpoint of making alloying with lithium difficult, the negative electrode current collector 50 may comprise at least one metal selected from Cu, Ni, and stainless steel. The negative electrode current collector 50 may have on the surface thereof some coating layer for the purpose of adjusting resistance. For example, the negative electrode current collector 50 may have a carbon coating layer. The negative electrode current collector 50 may be an aluminum foil having a carbon coating layer. The negative electrode current collector 50 may be a metal foil or a substrate plated or vapor-deposited with a metal described above. When the negative electrode current collector 50 consists of a plurality of metal foils, there may be some layer between the plurality of metal foils. The thickness of the negative electrode current collector 50 is not particularly limited, and for example, may be 0.1 μm or more or 1 μm or more, and may be 1 mm or less or 100 μm or less.

### 1.6 Additional Configurations

The lithium-ion battery 100, in addition to the above configurations, may be provided with any general configuration as a battery, for example, tabs or terminals. The above configurations of the lithium-ion battery 100 may each be housed inside an outer packaging. Any known outer packaging can be adopted as the outer packaging of the battery. In addition, a plurality of batteries 100 may be optionally connected electrically and optionally stacked to form a battery pack. In this case, the battery pack may be housed inside a known battery case. Examples of shapes of the lithium-ion battery 100 can include coin-type, laminate-type, cylindrical, and rectangular. The lithium-ion battery 100 may be a secondary battery.

### 2. Manufacturing Method for Lithium-Ion Battery

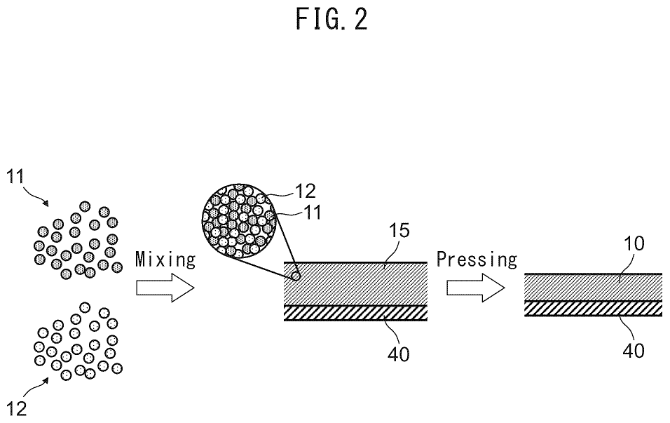

The above lithium-ion battery 100 can be manufactured by, for example, the following method. Specifically, as shown in FIG. 2, the manufacturing method for the lithium-ion battery 100 according to one embodiment comprises
mixing a positive electrode active material 11 having a Li-deficient O2-type structure and a sulfide solid electrolyte 12 to obtain a positive electrode mixture 15, and
pressing the positive electrode mixture 15 at a temperature of lower than 165° C. to obtain a positive electrode active material layer 10.

### 2.1 Mixing

The method of mixing the positive electrode active material 11 and the sulfide solid electrolyte 12 is not particularly limited. The positive electrode active material 11 and the sulfide solid electrolyte 12 may be mixed by a dry method, or may be mixed by a wet method using a solvent. The mixing means is also not particularly limited. For example, various mechanical mixing means such as a ball mill can be adopted. As stated above, optional components can be contained in the positive electrode active material layer 10 in addition to the positive electrode active material 11 and the sulfide solid electrolyte 12. Specifically, a positive electrode mixture 15 may be obtained by mixing optional components with the positive electrode active material 11 and the sulfide solid electrolyte 12. The positive electrode mixture 15 may be dispersed in a solvent to form a slurry. In this case, the solvent used is not particularly limited, and water and various organic solvents can be used. As shown in FIG. 2, the slurry is applied onto the surface of a positive electrode current collector 40 using a doctor blade, followed by drying, whereby the positive electrode mixture 15 can be layered on the surface of the positive electrode current collector 40.

### 2.2 Pressing

The positive electrode mixture 15 is pressed at a temperature of lower than 165° C., thereby obtaining the positive electrode active material layer 10. As shown in FIG. 2, the positive electrode active material layer 10 may be formed on the surface of the positive electrode current collector 40 by layering the positive electrode mixture 15 on the surface of the positive electrode current collector 40 and then pressing the positive electrode mixture 15 with the positive electrode current collector 40 in the layering direction. The pressing temperature is required to be lower than 165° C. When the pressing temperature is 165° C. or higher, the positive electrode active material 11 and the sulfide solid electrolyte 12 react, causing the PS₄ skeleton of the sulfide solid electrolyte 12 to collapse, and the above relationships (1) to (4) are no longer satisfied. The pressing temperature may be 160° C. or lower, 155° C. or lower, or 150° C. or lower. The lower limit of the pressing temperature is not particularly limited. The pressing temperature may be room temperature (25° C.) or higher, 50° C. or higher, 75° C. or higher, 100° C. or higher, or 125° C. or higher. The pressure during pressing is not particularly limited, and needs only to be a pressure that can densify the positive electrode mixture 15 to form the positive electrode active material layer 10. The pressing means needs only to be one that can suitably press the positive electrode mixture 15. For example, various pressing means such as a roll press can be adopted. The positive electrode mixture 15 may be pressed with the electrolyte layer 20 and negative electrode active material layer 30 described below. Specifically, in one embodiment, after obtaining a layered body comprising, in the order of, a positive electrode current collector 40, a positive electrode mixture 15, an electrolyte layer 20, a negative electrode active material layer 30, and a negative electrode current collector 50, the layered body may be pressed in the layering direction.

The positive electrode active material layer 10 is obtained via the above mixing and pressing. By combining the positive electrode active material layer 10 thus obtained, an electrolyte layer 20, and a negative electrode active material layer 30, a lithium-ion battery 100 can be manufactured, for example, as follows.
(1) A negative electrode active material that constitutes a negative electrode active material layer is dispersed in a solvent to obtain a negative electrode layer slurry. The solvent used in this case is not particularly limited, and water and various organic solvents can be used. The negative electrode layer slurry is applied onto a surface of a negative electrode current collector 50 using a doctor blade, followed by drying and optionally pressing, whereby a negative electrode active material layer 30 can be formed on the surface of the negative electrode current collector 50.
(2) Layers are layered so that an electrolyte layer 20 (solid electrolyte layer or separator) is sandwiched by the positive electrode active material layer 10 and the negative electrode active material layer 30 to obtain a layered body comprising, in the order of, a positive electrode current collector 40, a positive electrode active material layer 10, an electrolyte layer 20, a negative electrode active material layer 30, and a negative electrode current collector 50. When a solid electrolyte layer is adopted as the electrolyte layer 20, the layered body may be obtained by forming the solid electrolyte layer on a peelable substrate and then transferring the solid electrolyte layer to the positive electrode active material layer 10 or the negative electrode active material layer 30. Additional members such as terminals are attached to the layered body as needed.
(3) The layered body is housed in a battery case. When an electrolyte solution is contained, the electrolyte solution fills the inside of the battery case so that the layered body is immersed in the electrolyte solution, and then the layered body is sealed inside the battery case, thereby obtaining a lithium-ion battery 100.

### 3. Vehicle Comprising Lithium-Ion Battery

As stated above, the lithium-ion battery of the present disclosure has low resistance. Such a lithium-ion battery, for example, can be suitably used in at least one type of vehicle selected from hybrid vehicle (HEV), plug-in hybrid vehicle (PHEV), and battery electric vehicle (BEV). Specifically, the technique of the present disclosure has an aspect as a vehicle comprising a lithium-ion battery, wherein the lithium-ion battery comprises a positive electrode active material layer, an electrolyte layer, and a negative electrode active material layer, wherein the positive electrode active material layer comprises a positive electrode active material having a Li-deficient O2-type structure and a sulfide solid electrolyte, and a Raman spectrum of the positive electrode active material layer satisfies the above relationships (1) and (2).

### EXAMPLES

As stated above, one embodiment of the electrode active material has been described. However, various modifications to the technique of the present disclosure other than the above embodiments are possible without departing from the spirit thereof. Hereinafter, the technique of the present disclosure will be further described in detail with reference to the Examples. However, the technique of the present disclosure is not limited to the following Examples.

### 1. Production of Positive Electrode Active Material Having Li-Deficient O2-Type Structure

### 1.1 Production of Precursor

(1) MnSO₄·5H₂O, NiSO₄·6H₂O, and CoSO₄·7H₂O were weighed to a target compositional ratio and dissolved in distilled water to a concentration of 1.2 mol/L to obtain a first solution. In a separate container, Na₂CO₃ was dissolved in distilled water to a concentration of 1.2 mol/L to obtain a second solution.
(2) 1000 mL of pure water was loaded into a reactor (with baffles), and 500 mL of the first solution and 500 mL of the second solution were each added therein dropwise at a rate of about 4 mL/min.
(3) Upon completion of the dropwise addition, stirring was carried out at a stirring rate of 100 rpm at room temperature for 1 h to obtain a product.
(4) The product was washed with pure water and subjected to solid-liquid separation with a centrifugal separator to recover a precipitate.
(5) The resulting precipitate was dried overnight at 120° C. and pulverized with a mortar, and coarse particles and fine particles were separated by airflow classification. The coarse particles and fine particles both consisted of a composite salt comprising Mn, Ni, and Co. In the present Examples, of the coarse particles and the fine particles, the coarse particles were adopted as precursor particles. The coarse particles were spherical particles having an average particle size D50 of 3.5 μm.
   1.2 Production of composite
(1) Na₂CO₃ and distilled water were weighed to 1150 g/L and then stirred until complete dissolution using a stirrer to produce a Na₂CO₃ aqueous solution.
(2) The above Na₂CO₃ aqueous solution and the above precursor particles were weighed and mixed so as to have a composition of Na_{0.8}Mn_{0.5}Ni_{0.2}Co_{0.3}O₂ after the firing described below to obtain a slurry.
(3) The above slurry was gas-flow dried by spray drying to obtain a composite. Specifically, using a spray drying apparatus DL410, under the conditions of a slurry feed rate of 30 mL/min, an inlet temperature of 200° C., a circulating air volume of 0.8 m³/min, and a spraying air pressure of 0.3 MPa, the above slurry was gas-flow dried to cover the surfaces of the precursor particles with Na₂CO₃ to obtain a composite. In the composite, 70% by area or greater of the surfaces of the precursor particles were covered with Na₂CO₃.

### 1.3 Firing of Composite

The composite was loaded into an alumina crucible and fired under an ambient air atmosphere to obtain a Na-containing oxide having a P2-type structure. The firing conditions were as described in the following (1) to (5).
(1) An alumina crucible containing the above composite was set in a heating furnace in an ambient air atmosphere.
(2) Temperature inside the heating furnace was raised from room temperature (25° C.) to 600° C. in 115 min.
(3) Temperature inside the heating furnace was kept at 600° C. for 360 min to carry out pre-firing.
(4) After pre-firing, temperature inside the heating furnace was raised to 900° C. and kept at 900° C. for 60 min to carry out main firing.
(5) After main firing, temperature inside the heating furnace was lowered from 900° C. to 250° C., the alumina crucible was removed from the heating furnace at 250° C., and was left to cool outside the furnace in a dry atmosphere to reach 25° C. in 10 min.

The fired product after leaving to cool was crushed using a mortar under a dry atmosphere to obtain Na-containing oxide particles (P2-type particles) having a P2-type structure.

### 1.4 Ion Exchange

(1) LiNO₃ and LiCl were weighed to a molar ratio of 50:50 and mixed with the above P2-type particles at a molar ratio 10 times the minimum Li amount required for ion exchange to obtain a mixture.
(2) An alumina crucible was used to carry out ion exchange at 280° C. for 1 h under an ambient air atmosphere to obtain a product comprising a Li-containing oxide.
(3) Salt remaining in the product was washed away with pure water and the product was subjected to solid-liquid separation by vacuum filtration to obtain a precipitate.
(4) The resulting precipitate was dried overnight at 120° C. to obtain a positive electrode active material. The chemical composition of the positive electrode active material was Li_{0.7}Mn_{0.5}Ni_{0.2}Co_{0.3}O₂. The crystal phase contained in the positive electrode active material was confirmed by XRD, where it was found that the positive electrode active material had an O2-type structure. Specifically, the positive electrode active material had a Li-deficient O2-type structure.

### 2. Production of Non-Li-Deficient (Li-Doped) Positive Electrode Active Material

The above positive electrode active material having a Li-deficient O2-type structure was doped with Li to produce a non-Li-deficient positive electrode active material. Specifically, 9-fluorenone was mixed and dissolved in tetrahydrofuran (THF) to 1 mol/L inside a glove box (Ar atmosphere) to obtain a fluorenone solution. Li foil at the same number of moles as the fluorenone was further added in the fluorenone solution and stirred for 2 h to obtain a reducing solution comprising 1 mol/L of Li ions. The above positive electrode active material was added, immersed, and stirred in the obtained reducing solution for 24 h. After stirring, the positive electrode active material was washed with THF and subjected to solid-liquid separation by vacuum filtration. The resulting precipitate was dried overnight at 120° C. to obtain a non-Li-deficient positive electrode active material. The chemical composition of the positive electrode active material was Li_{1.0}Mn_{0.5}Ni_{0.2}Co_{0.3}O₂. The crystal phase contained in the positive electrode active material was confirmed by XRD, where it was found that the positive electrode active material had an O2-type structure.

### 3. Preparation of Positive Electrode Active Material Having 03-Type Structure

As a positive electrode active material having a non-Li-deficient O3-type structure, a commercially available NCA-based positive electrode active material was prepared.

### 4. Production of Evaluation Cell

Each of the above positive electrode active materials was used to produce an evaluation cell. The production procedure of the evaluation cell was as follows.

(1) A positive electrode active material, a sulfide solid electrolyte (Li₂S—P₂S₅—LiI—LiBr), PVDF, and VGCF were weighed so that positive electrode active material: sulfide solid electrolyte: PVDF: VGCF=81.1:15.9:0.6:2.4 (mass ratio) and mixed to obtain a positive electrode mixture. The resulting positive electrode mixture was dispersed in a solvent (butyl butyrate) to obtain a positive electrode slurry. The resulting positive electrode slurry was applied onto a positive electrode current collector (A1 foil) and dried, followed by pressing at a pressing temperature as indicated in Table 1 below and a line pressure of 100 kN with a roll press to form a positive electrode active material layer on a surface of the positive electrode current collector.

(2) A negative electrode active material (lithium titanate), a sulfide solid electrolyte (Li₂S—P₂S₅—LiI—LiBr), PVDF, and VGCF were weighed so that negative electrode active material: sulfide solid electrolyte: PVDF: VGCF=72.1:22.7:3.5:1.7 (mass ratio) and mixed to obtain a negative electrode mixture. The resulting negative electrode mixture was dispersed in a solvent (butyl butyrate) to obtain a negative electrode slurry. The resulting negative electrode slurry was applied onto a negative electrode current collector (Cu foil) and dried, followed by pressing at room temperature (25° C.) and a line pressure of 60 kN with a roll press to form a negative electrode active material layer on a surface of the negative electrode current collector.

(3) A sulfide solid electrolyte (Li₂S—P₂S₅—LiI—LiBr) and acrylate-butadiene rubber (ABR) were weighed so that sulfide solid electrolyte: ABR=99.4:0.6 (mass ratio) and mixed to obtain an electrolyte mixture.

(4) The electrolyte mixture was interposed between the above positive electrode active material layer and the above negative electrode active material layer to obtain a layered body comprising, in the order of, a positive electrode current collector, a positive electrode active material layer, a solid electrolyte layer, a negative electrode active material layer, and a negative electrode current collector. The resulting layered body was pressed at room temperature (25° C.) and a surface pressure of 50 kN to obtain an evaluation cell (solid battery).

### 4. Raman Measurement and XPS Measurement

Inside a glove box, the positive electrode current collector (A1 foil) was peeled from the above evaluation cell and removed to expose the positive electrode active material layer, and then Raman measurement and XPS measurement were carried out on the outermost surface of the positive electrode active material layer to acquire Raman and XPS spectra (S2p and P2p). As Reference Example, a positive electrode mixture was layered on the surface of a positive electrode current collector, and without pressing, Raman and XPS spectra of the positive electrode mixture were acquired as-is. Note that, Raman measurements were normalized (background-processed) with intensity at 300 cm⁻¹ as 0. In addition, XPS measurements were normalized (background-processed) with peak intensities at 138 eV and 170 eV as 0.

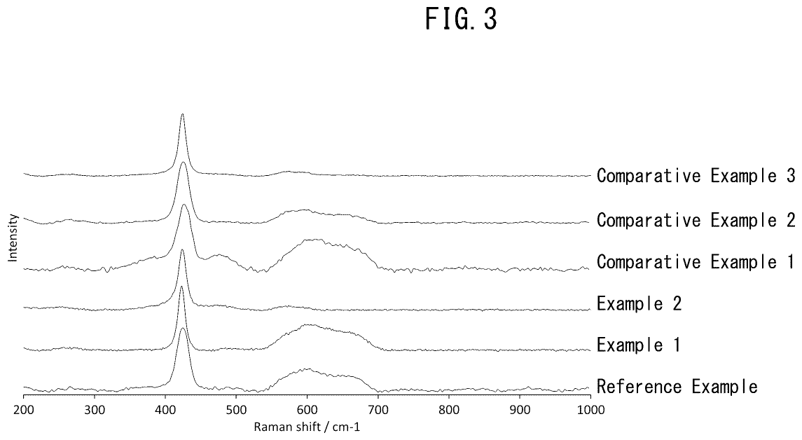

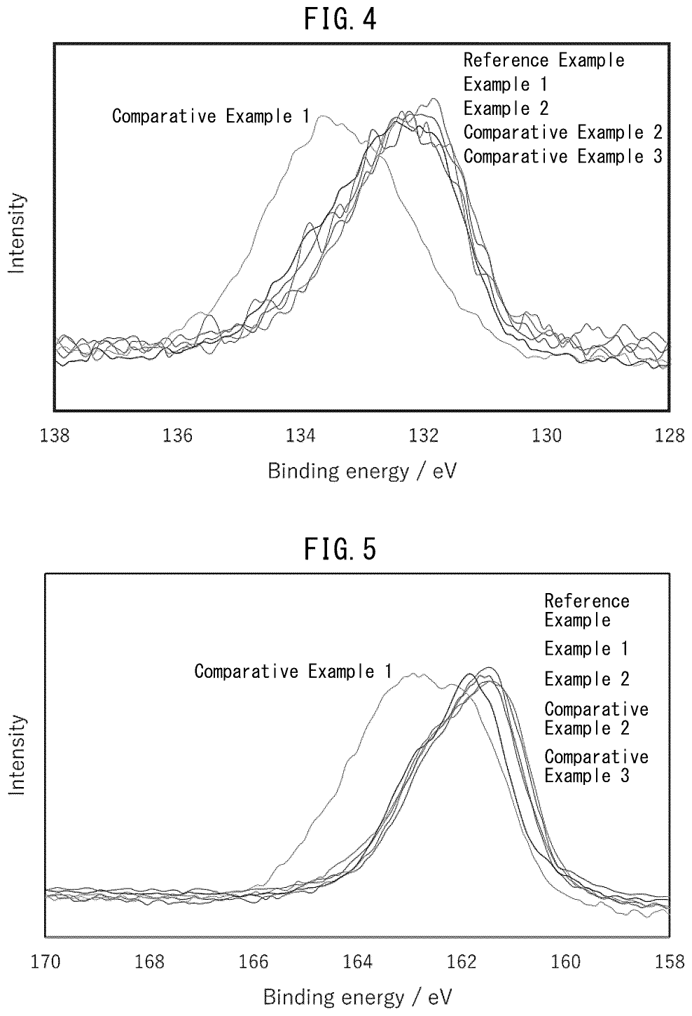

FIG. 3 shows a Raman spectrum for each of the Examples, Comparative Examples, and Reference Example. FIG. 4 shows an XPS spectrum (P2p) for each of the Examples, Comparative Examples, and Reference Example. FIG. 5 shows an XPS spectrum (S2p) for each of the Examples, Comparative Examples, and Reference Example.

The peak intensity at 385 cm⁻¹ was identified as the peak intensity IR from P₂S₆⁴⁻ in the Raman spectrum. The peak intensity at 420 cm⁻¹ was identified as the peak intensity I_{R2} from PS₄³⁻ in the Raman spectrum. The peak intensity at 475 cm⁻¹ was identified as the peak intensity I_{R3} from S—S in the Raman spectrum. Calculation results of peak intensity ratios I_{R1}/I_{R2} and I_{R3}/I_{R2} are shown in Table 1 below.

The peak intensity at 162.9 eV was identified as the peak intensity I_{X1} from P—S—P in the XPS spectrum for S2p. The peak intensity at 161.6 eV was identified as the peak intensity I_{X2} from PS₄³⁻ in the XPS spectrum for S2p. Calculation results of peak intensity ratio I_{X1}/I_{X2} are shown in Table 1 below.

The peak intensity at 133.6 eV was identified as the peak intensity I_{X3} from POₓS₄₋ₓ³⁻ in the XPS spectrum for P2p. The peak intensity at 132.2 eV was identified as the peak intensity I_{X4} from PS₄³⁻ in the XPS spectrum for P2p. Calculation results of peak intensity ratio I_{X3}/I_{X4} are shown in Table 1 below.

### 5. Evaluation of Charge-Discharge Characteristics

For each of the evaluation cells, a 2-cycle charge-discharge test was carried out at a voltage range of 1.8 to 4.6 V and 0.1 C (1 C=220 mA/g) in an isothermal chamber maintained at 25° C. DCIR resistance was then measured by applying a current equivalent to 3 C for 10 s at a SOC of 50% (2.35 V vs. LTO) in an isothermal chamber maintained at 25° C. Measurement results are shown in Table 1 below.

### 6. Evaluation Results

For each of Examples 1 and 2 and Comparative Example 1 (when a positive electrode active material having a Li-deficient O2-type structure was used), Comparative Example 2 (when a positive electrode active material having a non-Li-deficient (Li-doped) O2-type structure was used), Comparative Example 3 (when a positive electrode active material having a non-Li-deficient O3-type structure was used), and Reference Example (positive electrode mixture), the type of positive electrode active material, presence/absence of pressing of positive electrode mixture, pressing temperature, peak intensity ratios I_{R1}/I_{R2} and I_{R3}/I_{R2} of the Raman spectrum, peak intensity ratios I_{X1}/I_{X2} and I_{X3}/I_{X4} of the XPS spectrum, and resistance measurement result are shown.

TABLE 1

| | | Pressing | | | | | | |
|---|---|---|---|---|---|---|---|---|
| | Active | | Temperature | Raman | | XPS | | Resistance |
| | material type | Yes/No | (° C.) | I_{R1}/I_{R2} | I_{R3}/I_{R2} | I_{X1}/I_{X2} | I_{X3}/I_{X4} | (Ω) |
| Reference | Li-deficient O2 | No | N/A | 0.04 | 0.00 | 0.64 | 0.53 | N/A |
| Example | | | | | | | | |
| Example 1 | Li-deficient O2 | Yes | 25 | 0.02 | 0.01 | 0.57 | 0.39 | 49.2 |
| Example 2 | Li-deficient O2 | Yes | 150 | 0.07 | 0.08 | 0.60 | 0.39 | 49.0 |
| Comparative | Li-deficient O2 | Yes | 165 | 0.22 | 0.25 | 1.27 | 1.71 | 50.7 |
| Example 1 | | | | | | | | |
| Comparative | Li-doped O2 | Yes | 165 | 0.04 | 0.02 | 0.66 | 0.63 | N/A |
| Example 2 | | | | | | | | |
| Comparative | NCA | Yes | 165 | 0.04 | 0.03 | 0.53 | 0.53 | N/A |
| Example 3 | | | | | | | | |

The following was found from the results shown in Table 1 and FIGS. 3 to 5.

The evaluation cells according to Examples 1 and 2, wherein I_{R1}/I_{R2} was 0.20 or less; I_{R3}/I_{R2} was 0.20 or less; I_{X1}/I_{X2} was 1.20 or less; and I_{X3}/I_{X4} was 1.60 or less, had lower resistance than the evaluation cell according to Comparative Example 1, wherein I_{R1}/I_{R2} was greater than 0.20; I_{R3}/I_{R2} was greater than 0.20; I_{X1}/I_{X2} was greater than 1.20; and I_{X3}/I_{X4} was greater than 1.60. From the comparison between Examples 1 and 2 and Comparative Example 1, it was found that when a positive electrode active material having a Li-deficient O2-type structure and a sulfide solid electrolyte are combined in a positive electrode mixture, and the positive electrode mixture is then pressed at a temperature of 165° C. or higher, the positive electrode active material and the sulfide solid electrolyte react, causing the PS₄ skeleton of the sulfide solid electrolyte to collapse and generating by-products. In Comparative Example 1, it is considered that the by-products increased the resistance of the evaluation cell.

In Comparative Example 2 and Comparative Example 3, wherein a non-Li-deficient positive electrode active material was used, even when the positive electrode mixture was pressed at 165° C., no by-products were observed and the PS₄ skeleton of the sulfide solid electrolyte was maintained. Specifically, it can be understood that the problem of resistance increase due to the reaction between the positive electrode active material and the sulfide solid electrolyte is specific to the case where a positive electrode active material having a Li-deficient O2-type structure and a sulfide solid electrolyte are combined in a positive electrode active material layer.

### 7. Supplemental

Although the above Examples exemplify a case where a positive electrode active material having a Li-deficient O2-type structure had a specific chemical composition, the chemical composition of the positive electrode active material is not particularly limited. Further, the chemical composition of the sulfide solid electrolyte is not limited to those described above. When a positive electrode active material layer is formed using a positive electrode active material having a Li-deficient O2-type structure and a sulfide solid electrolyte, it is considered that the same effect can be achieved regardless of the chemical compositions of the positive electrode active material and the sulfide solid electrolyte.

### 8. Summary

As stated above, in a lithium-ion battery comprising a positive electrode active material layer, an electrolyte layer, and a negative electrode active material layer, when the following requirements (A) and (B) are satisfied, it can be said that the lithium-ion battery has low resistance.
(A) The positive electrode active material layer comprises a positive electrode active material having a Li-deficient O2-type structure and a sulfide solid electrolyte.
(B) A Raman spectrum of the positive electrode active material layer satisfies relationships (1) and (2) below:

$${I}_{R 1} / {I}_{R 2} \leq 0.2 ; \qquad ( 1 )$$

$${I}_{R 3} / {I}_{R 2} \leq 0.2 ; \qquad ( 2 )$$

I_{R1}: peak intensity from P₂S₆⁴⁻ in the Raman spectrum;
I_{R2}: peak intensity from PS₄³⁻ in the Raman spectrum;
I_{R3}: peak intensity from S—S in the Raman spectrum.

In addition to the above requirements (A) and (B), when the requirement (C) described below is satisfied, it can be said that the lithium-ion battery has even lower resistance.
(C) An XPS spectrum of the positive electrode active material layer satisfies relationships (3) and (4) below:

$${I}_{X 1} / {I}_{X 2} \leq 1.2 ; \qquad ( 3 )$$

$${I}_{X 3} / {I}_{X 4} \leq 1.6 ; \qquad ( 4 )$$

I_{X1}: peak intensity from P—S—P in the XPS spectrum for S2p;
I_{X2}: peak intensity from PS₄³⁻ in the XPS spectrum for S2p;
I_{X3}: peak intensity from POₓS₄₋ₓ³⁻ in the XPS spectrum for P2p;
I_{X4}: peak intensity from PS₄³⁻ in the XPS spectrum for P2p.

### REFERENCE SIGNS LIST

100 lithium-ion battery
   10 positive electrode active material layer
      11 positive electrode active material having a Li-deficient O2-type structure
      12 sulfide solid electrolyte
      15 positive electrode mixture
   20 electrolyte layer
   30 negative electrode active material layer
   40 positive electrode current collector
   50 negative electrode current collector

The invention claimed is:

1. A lithium-ion battery, comprising a positive electrode active material layer, an electrolyte layer, and a negative electrode active material layer, wherein
the positive electrode active material layer comprises
a positive electrode active material having a Li-deficient O2-type structure and
a sulfide solid electrolyte, and
a Raman spectrum of the positive electrode active material layer satisfies relationships (1) and (2) below:
$${I}_{R 1} / {I}_{R 2} \leq 0.2 ; \qquad ( 1 )$$
$${I}_{R 3} / {I}_{R 2} \leq 0.2 ; \qquad ( 2 )$$
I_{R1}: peak intensity from P₂S₆⁴⁻ in the Raman spectrum;
I_{R2}: peak intensity from PS₄³⁻ in the Raman spectrum;
I_{R3}: peak intensity from S—S in the Raman spectrum.

2. The lithium-ion battery according to claim 1, wherein
an XPS spectrum of the positive electrode active material layer satisfies relationships (3) and (4) below:
$${I}_{X 1} / {I}_{X 2} \leq 1.2 ; \qquad ( 3 )$$
$${I}_{X 3} / {I}_{X 4} \leq 1.6 ; \qquad ( 4 )$$
I_{X1}: peak intensity from P—S—P in the XPS spectrum for S2p;
I_{X2}: peak intensity from PS₄³⁻ in the XPS spectrum for S2p;
I_{X3}: peak intensity from POₓS₄₋ₓ³⁻ in the XPS spectrum for P2p;
I_{X4}: peak intensity from PS₄³⁻ in the XPS spectrum for P2p.

3. The lithium-ion battery according to claim 1, wherein
when an entire solid content contained in the positive electrode active material layer is 100% by mass,
a content of the positive electrode active material is 40% by mass or greater and less than 100% by mass, and
a content of the sulfide solid electrolyte is greater than 0% by mass and 60% by mass or less.

4. The lithium-ion battery according to claim 1, wherein
the positive electrode active material has a chemical composition represented by LiₐNa_{b}Mnₓ₋ₚNi_{y-q}Co_{z-r}M_{p+q+r}O₂, where 0<a<1.00; 0≤b≤0.20; x+y+z=1; and 0≤p+q+r<0.17, and an element M is at least one selected from B, Mg, Al, K, Ca, Ti, V, Cr, Fe, Cu, Zn, Ga, Ge, Sr, Y, Zr, Nb, Mo, and W.

5. The lithium-ion battery according to claim 1, wherein
the electrolyte layer comprises a solid electrolyte.

6. A manufacturing method for a lithium-ion battery, the method comprising
mixing a positive electrode active material having a Li-deficient O2-type structure and a sulfide solid electrolyte to obtain a positive electrode mixture, and
pressing the positive electrode mixture at a temperature of lower than 165° C. to obtain a positive electrode active material layer.
